(19) United States
(12) Patent Application Publication
(10) Pub. No.: US 2009/0300494 A1
(43) Pub. Date: Dec. 3, 2009

(54) USER ASSISTANCE PANEL

(75) Inventors: Heather E. Cottingham, San Francisco, CA (US); Lydia Naylor, Foster City, CA (US); Louise Raffo, Reading (GB); Juliette Fleming, Linlithgow (GB); Juli Anne Tolley, Valencia, CA (US); Catherine Sue Bauer, San Clemente, CA (US); Kristin Penaskovic, San Jose, CA (US); J. Anne Carlson, Redwood City, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/129,130

(22) Filed: May 29, 2008

(51) Int. Cl. G06F 3/048

(52) U.S. Cl. 715/708

(57) ABSTRACT

A system for providing user assistance receives a request for help content for a first component of a plurality of components displayed on a user interface page. The system generates a user assistance panel that is displayed simultaneously with the user interface page without substantially obscuring the user interface page. The user assistance panel includes the help content for the first component and a heading for a second component of the plurality of components that has associated help content.

### FIELD OF THE INVENTION

One embodiment is directed generally to a computer application, and in particular to user help or assistance for a computer application.

### BACKGROUND INFORMATION

Software applications, including applications running on a stand-alone computer (“native applications”) as well as web-based applications, typically provide user assistance or “help” via an external help system. With an external help system, a user requests help assistance usually by clicking a button or pressing a key, and a separate window is typically generated. In many applications, the window has a tri-pane layout that is capable of showing Hypertext Markup Language (“HTML”) pages written by help authors as well as some navigation aids, such as a table of contents. Examples of external help systems with tri-pane windows can be found in the Internet Explorer browser from Microsoft Corp. (i.e., a help window generated in response to pressing the F1 key) and the Adobe Reader (i.e., a help window generated through interaction with the Help menu) from Adobe Systems, Inc.

To initiate an external help system, the application's user interface typically includes special purpose controls. For example, many applications have a Help menu that allows access to the external help system. In addition, parts of the application that are specific to a certain task, such as a dialog or panel in a native application, or a page in a web application, may have a button or link that launches the external help system while passing a specific “topic id” that identifies the topic in the external help system that is relevant to that part of the user interface. This is referred to as a “context-sensitive” help request.

External help systems have a few disadvantages. For one, users have to deliberately perform a certain action (e.g., using the Help menu, clicking on the Help button, pressing the F1 key, etc.) in order to see the help content for the task they are performing. However, usability studies have shown that some users are reluctant to perform that action—they would rather try to figure it out themselves rather than “ask” for help. In addition, because external help systems launch in a separate window or page, they naturally take focus away from the application. This new page either replaces the user's current page or opens a new page, obscuring the user's original page.

Other help systems avoid the opening of a new page by dedicating an area of the page to help text. However, this takes away screen real estate.

Further, most known help systems do not differentiate between types of users. All users get the same help, regardless of whether they are an end-user or a system administrator. If different types of help exist, the user typically must go to another system entirely.

Further, with help systems that require users to enter a search for help, the users are less likely to find the answer, again decreasing the likelihood that they will complete their task successfully, because the language used by application developers and help creators does not usually match those of the user. Users first have to determine if they are using the correct verbiage to find the answer to their question. Since most application searches use specific text to describe functionality, there are often discrepancies between the vocabulary of a user and the help creator.

### SUMMARY OF THE INVENTION

One embodiment is a system for providing user assistance. The system receives a request for help content for a first component of a plurality of components displayed on a user interface page. The system generates a user assistance panel that is displayed simultaneously with the user interface page without substantially obscuring the user interface page. The user assistance panel includes the help content for the first component and a heading for a second component of the plurality of components that has associated help content.

### BRIEF DESCRIPTION OF THE DRAWINGS

FIG. 1 is a block diagram of a computer or system that can implement an embodiment of the present invention.

FIG. 2 is an illustration of a user interface generated by a software application and a User Assistance Panel module in accordance with one embodiment.

FIG. 3 is an illustration of a user interface after a user has selected an icon of the user interface of FIG. 2, which corresponds to the “Segments” section, in accordance with one embodiment.

FIG. 4 illustrates a page that is opened as a result of the selection of a link of FIG. 3 in accordance with one embodiment.

FIG. 5 is a flow diagram of the functionality of the computer, including the user assistance panel module, when providing a user assistance panel.

### DETAILED DESCRIPTION

One embodiment is a system that provides help information via a user assistance panel that opens up when a help icon is selected. The user assistance panel provides targeted help information without distracting the user from the current page and task.

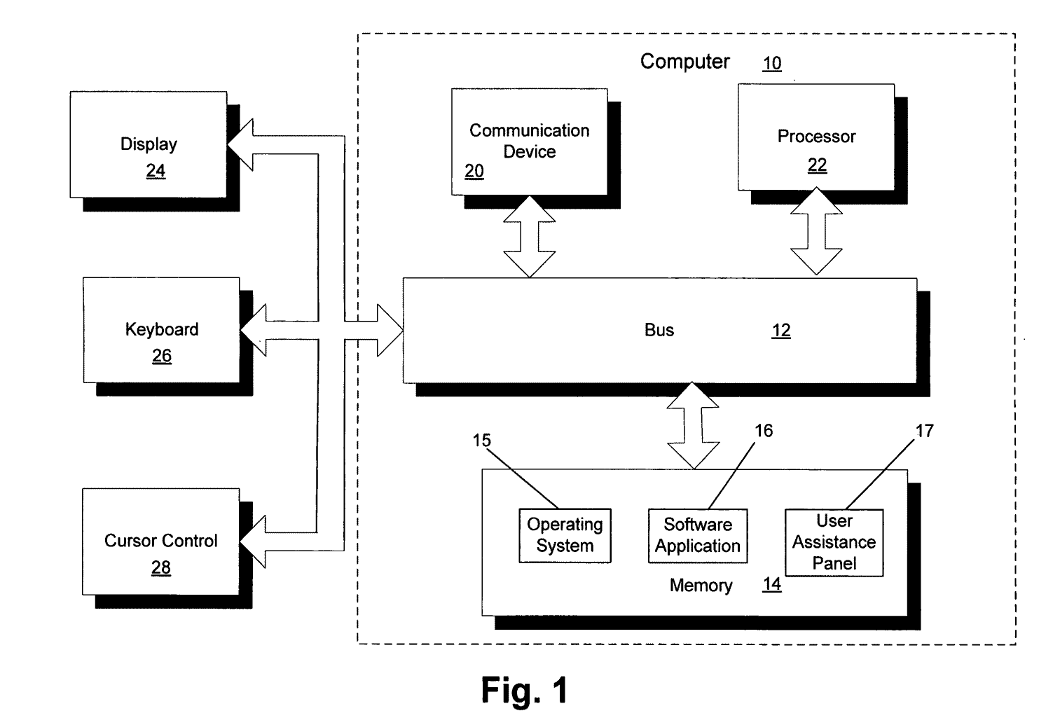

FIG. 1 is a block diagram of a computer or system 10 that can implement an embodiment of the present invention. Computer 10 includes a bus 12 or other communication mechanism for communicating information, and a processor 22 coupled to bus 12 for processing information. Processor 22 may be any type of general or specific purpose processor. Computer 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. Computer 10 further includes a communication device 20, such as a network interface card, to provide access to a network.

Computer readable media may be any available media that can be accessed by computer 10 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Computer 10 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with computer 10.

In one embodiment, memory 14 stores an operating system 15 and a native software application 16 such as a word processing or spreadsheet application. Memory 14 further stores a User Assistance Panel module 17 that, when executed by processor 22, performs the functionality disclosed below. The functionality of User Assistance Panel module 17 in one embodiment is integrated with application 16. In another embodiment, communication device 20 is coupled to the Internet or other network, and computer 10 executes an Internet browser, such as the Internet Explorer from Microsoft Corp., and executes a web-based software application via the browser and via an Internet web server that transmits and receives data over the Internet. In this embodiment, software application 16 and User Assistance Panel module 17 are located and executed on the web server and displayed on computer 10 via that browser.

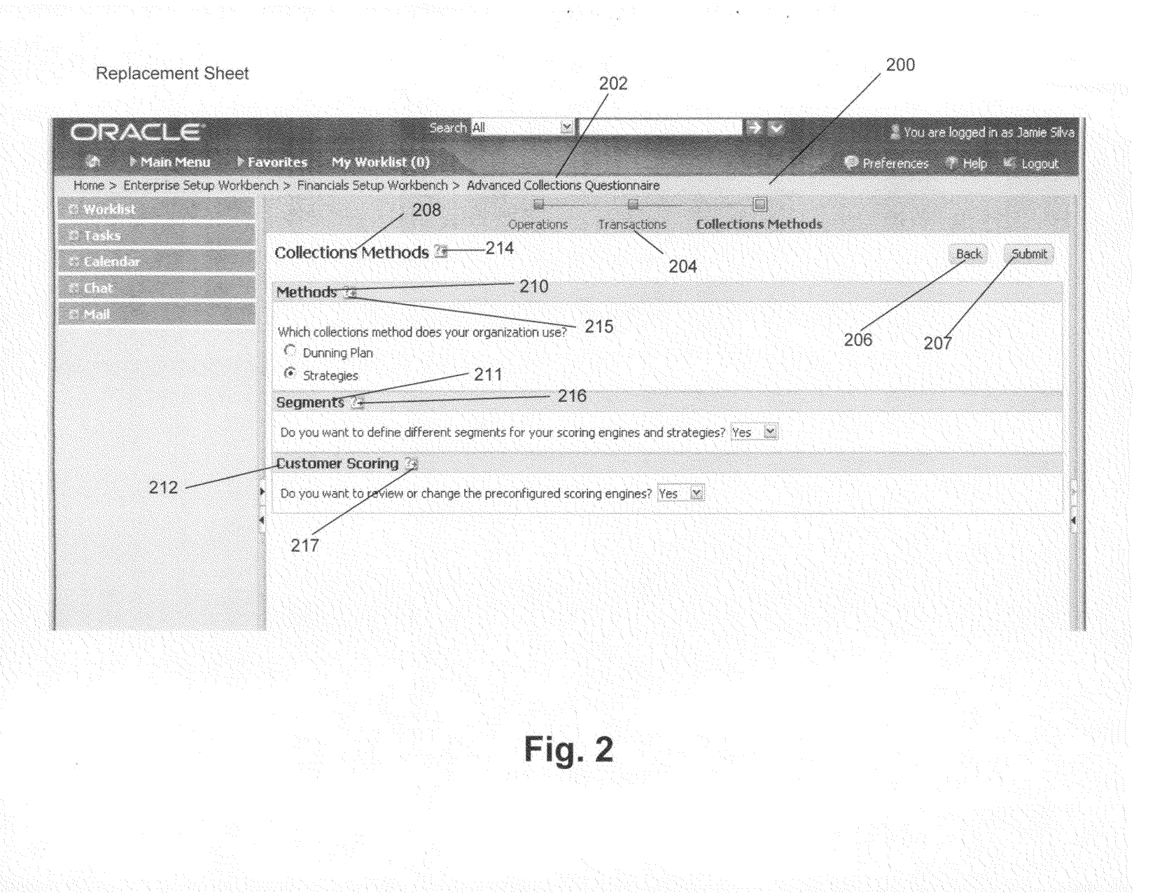

FIG. 2 is an illustration of a user interface (“UI”) 200 generated by software application 16 and User Assistance Panel module 17 in accordance with one embodiment. UI 200 is one page from a multi-page task flow. In general, a task flow includes one or more pages and a control flow that defines the navigation between the pages. UI 200 includes the title 202 or overall task flow subject of the task flow, “Advanced Collections Questionnaire”, and a progress flow 204 that indicates which page of the multi-page task flow is currently being displayed, and the progress or order of the other pages. Progress flow 204 indicates that the “Collections Methods” task flow page is currently displayed, and that the “Operations” and “Transactions” pages must be completed before the “Collections Methods” is completed.

UI 200 further includes “components” that may have associated help information, such as the title or subject 208 of the current task flow page (“Collections Method”) and one or more “sections” 210-212, each of which may require a user input to move onto the next task flow page. For title 208, or sections 210-212, or any other components, if there is help information available, an icon 214-217 will appear next to the component. Icons 214-217 can be selected by a user by, for example, clicking on the icon, which opens up a user assistance panel disclosed below. The user assistance panel will be specific and relevant to the component that corresponds to the selected icon. UI 200 further includes a back button 206, which returns to the previous task flow page (i.e., the “transactions” task flow page as indicated by progress flow 204). UI 200 further includes a submit button 207 which allows the user to submit the user input for sections 210-212.

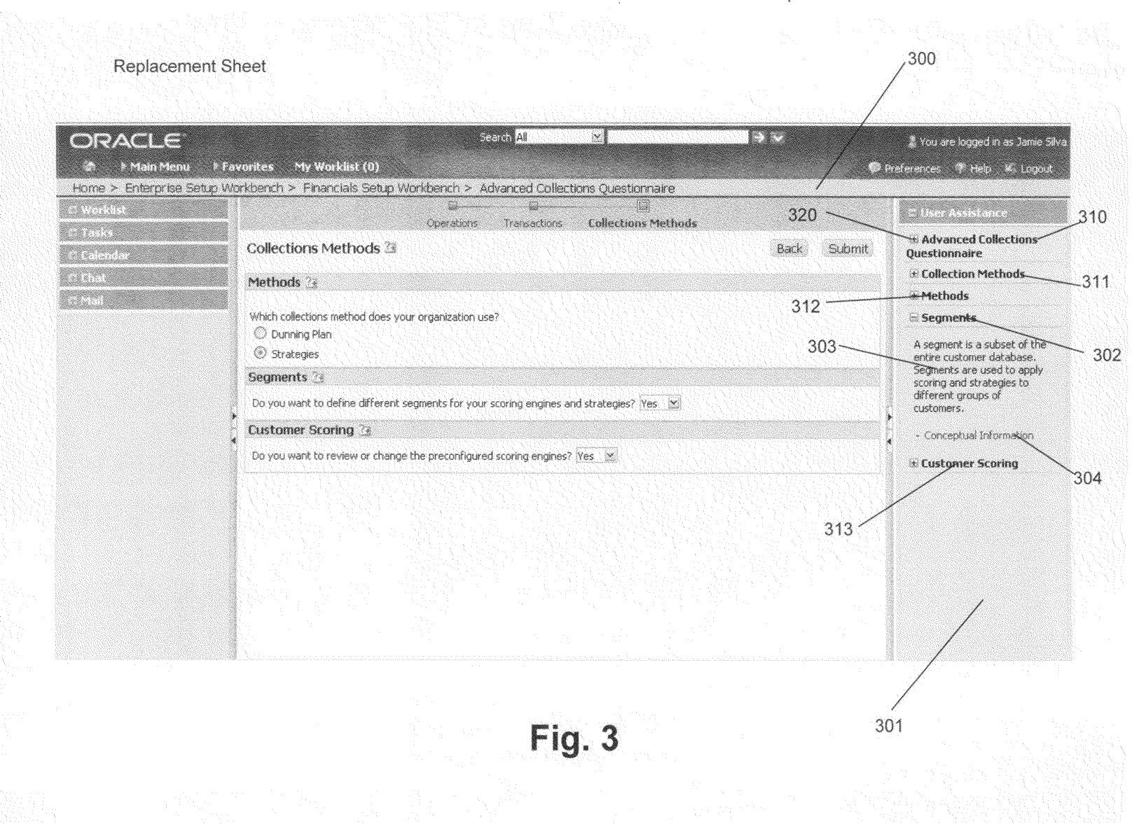

FIG. 3 is an illustration of a UI 300 after a user has selected icon 216 of UI 200 of FIG. 2, which corresponds to the “Segments” section, in accordance with one embodiment. As a result of clicking on icon 216, a user assistance panel 301 opens up and displays relevant help information. User assistance panel 301 is in the form of a side pane and does not cover up any portion of UI 200 that is shown in FIG. 2. Instead, the content of UI 200 shrinks to accommodate user assistance panel 301.

User assistance panel 301 includes targeted help information 303 for the “Segments” section, which is the component that corresponded to selected icon 216. Help information 303, and all of the help information on user assistance panel 301, may vary depending on the role or type of user. For example, the user may logon to application 16, and the logon information may identify the user as an end-user, system administrator, application developer, etc. Based on this identity, the content of user assistance panel 301 may vary.

In one embodiment, the help content on user assistance panel 301 is generally short, but conceptual in nature. It does not include step by step instructions on how to complete a task nor is it simply a definition of a term (although that may be part of it). If there is additional help information, usually in the form of frequently asked questions (“FAQs”), examples, etc, one or more links 304 are provided, rather than forcing a user to search for it.

In one embodiment, all components on UI 200 that have associated help are automatically shown as headings in user assistance panel 301 but are closed to prevent information overload, as shown by unexpanded information 310-313. The user may select an expand button (e.g., expand button 320) to view help information for additional components and to view any links for that help subject.

In another embodiment, the heading of the user assistance panel 301 (e.g., “segments” heading 302, “customer scoring” heading 313, etc.) are links that generate a search query when selected. Clicking on one of the headings initiates a search using contextual information from the page (e.g., the user role, the page, the page region, etc.). The search results may be shown in a separate window or in the panel itself as a list of topic titles with abstracts, so that the user can choose the most appropriate topic for further reading.

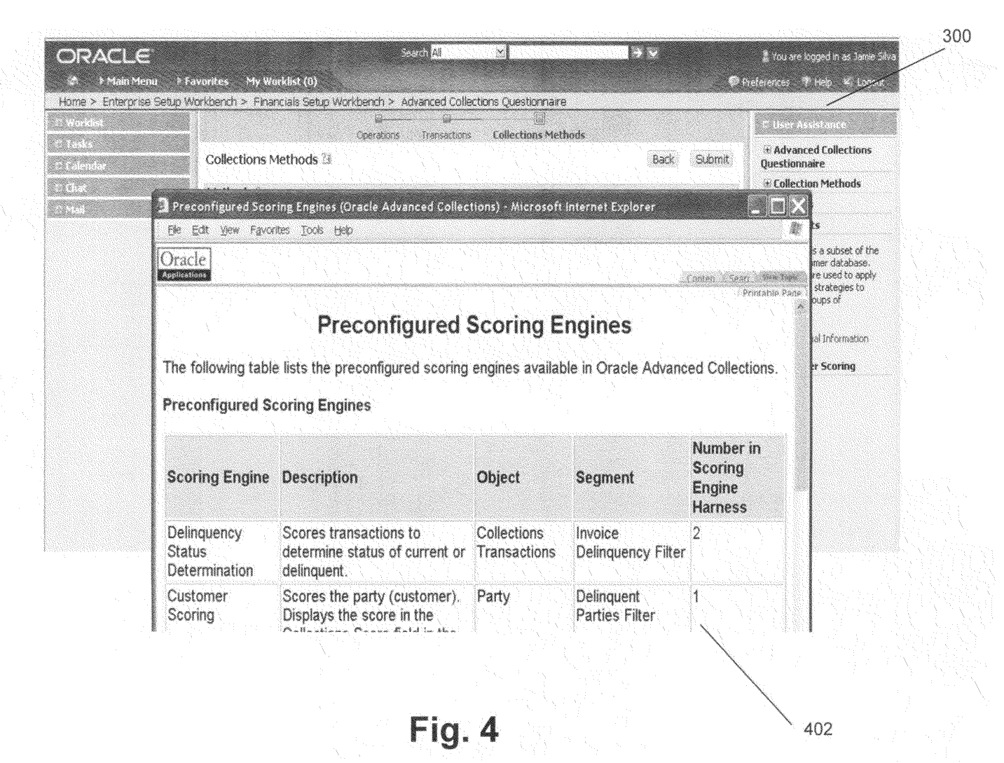

The one or more links of user assistance panel 301 in one embodiment opens a second page or window that provides additional help information, in order to prevent the user from losing their work or place in the task flow. FIG. 4 illustrates a page 402 that is opened as a result of the selection of link 304 of FIG. 3 in accordance with one embodiment. As shown, page 402 provides help information in addition to what is available on user assistance panel 301. In another embodiment, the links open up a second panel on the user interface rather than a second window.

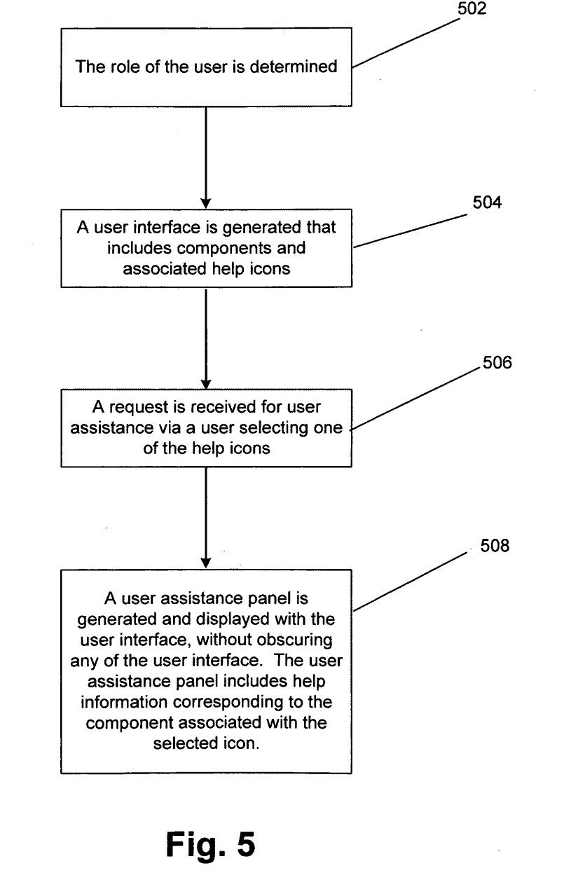

FIG. 5 is a flow diagram of the functionality of computer 10, including user assistance panel module 17, when providing a user assistance panel. In one embodiment, the functionality of the flow diagram of FIG. 5 is implemented by software stored in memory or other computer readable or tangible medium, and executed by a processor. In other embodiments, the functionality can be performed by hardware, or any combination of hardware and software.

At 502, the role of the user is determined. In one embodiment, this is determined by requiring the user to logon to computer 10 before software application 16 is provided. The logon information will determine if the user is an end user, system administrator, etc.

At 504, a user interface is generated that includes components such as subjects, titles, etc. For each component that has associated help information, a help icon is generated next to the component. Therefore, users see immediately if help exists for a component by viewing the icon. They do not have to first search to see if it exists. The decision to generate a help icon for a component may depend on the role of the user. In one embodiment, the user interface is one page from within a multi-page task flow.

At 506, a request is received for user assistance via a user selecting one of the help icons.

At 508, in response to the request, a user assistance panel is generated and displayed simultaneously with the user interface, without obscuring any of the user interface. The user assistance panel includes help information corresponding to the component associated with the selected icon. The user assistance panel further includes unexpanded help information for the remaining components on the user interface page. The help information may include links to additional pages. The content of the help information may depend on the role of the user.

As disclosed, help information is provided in the form of a user assistance panel which directly provides relevant help to the user without obscuring the current page or directing the user to a new page. Therefore, the user can easily obtain help information without being distracted from the current task and without requiring any searching.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable media having instructions stored thereon that, when executed by a processor, causes the processor to:
receive a request for a first help content for a first component of a plurality of components displayed on a user interface page; and
generate a user assistance panel that is displayed simultaneously with the user interface page without substantially obscuring the user interface page;
wherein the user assistance panel comprises the first help content for the first component and a heading for a second component of the plurality of components that has associated help content.

2. The computer readable media of claim 1, wherein the heading for the second component is capable of being expanded to display second help content for the second component.

3. The computer readable media of claim 1, wherein the first help content comprises a first link for additional help content for the first component.

4. The computer readable media of claim 3, wherein the instructions further cause the processor to generate a second page upon selection of the first link.

5. The computer readable media of claim 1, wherein the request is generated based on a selection of a help icon.

6. The computer readable media of claim 1, wherein the first help content is based on a type of user.

7. The computer readable media of claim 1, wherein the user interface page is one page of a multi-page task flow.

8. A method of providing user assistance comprising:
receiving a request for a first help content for a first component of a plurality of components displayed on a user interface page; and
generating a user assistance panel that is displayed simultaneously with the user interface page without substantially obscuring the user interface page;
wherein the user assistance panel comprises the first help content for the first component and a heading for a second component of the plurality of components that has associated help content.

9. The method of claim 8, further comprising expanding the heading to display second help content for the second component.

10. The method of claim 8, wherein the first help content comprises a first link for additional help content for the first component.

11. The method of claim 10, further comprising generating a second page upon selection of the first link.

12. An apparatus for providing user assistance comprising:
means for receiving a request for a first help content for a first component of a plurality of components displayed on a user interface page; and
means for generating a user assistance panel that is displayed simultaneously with the user interface page without substantially obscuring the user interface page;
wherein the user assistance panel comprises the first help content for the first component and a heading for a second component of the plurality of components that has associated help content.

13. A system comprising:
a processor;
a memory coupled to the processor; and
a user assistance panel module stored in the memory;
wherein the processor, in response to receiving a request for a first help content for a first component of a plurality of components displayed on a user interface page, is adapted to generate a user assistance panel that is displayed simultaneously with the user interface page without substantially obscuring the user interface page;
wherein the user assistance panel comprises the first help content for the first component and a heading for a second component of the plurality of components that has associated help content.
